(19) United States
(12) Patent Application Publication
(10) Pub. No.: US 2016/0222179 A1
(43) Pub. Date: Aug. 4, 2016

(54) ORGANIC SUBSTRATES HAVING IMPROVED WEATHERABILITY AND MAR RESISTANCE

(71) Applicant: RADCO INFUSION TECHNOLOGIES, LLC, Toledo, OH (US)

(72) Inventors: Rick Anderson, Waterville, OH (US); Richard Yorde, Howard, OH (US)

(73) Assignee: RADCO Infusion Technologies, LLC, Toledo, OH (US)

(21) Appl. No.: 14/917,760

(22) PCT Filed: Sep. 9, 2014
(86) PCT No.: PCT/US2014/054717

§ 371 Date: Mar. 9, 2016

Related U.S. Application Data
(60) Provisional application No. 61/875,152, filed on Sep. 9, 2013.

(51) Int. Cl. C08J 7/06

(52) U.S. Cl. CPC C08J 7/065; C08J 7/06; C08J 2300/22; C08J 2369/00; C08J 2367/02

(57) ABSTRACT

There is a great desire for new organic resin materials that have acceptable weatherability and scratch resistance. Provided are processes and organic resin materials that address these needs. Such materials include a thermoplastic substrate, an adhesion promoter infused into a surface of the thermoplastic such that an inorganic component (IC) of the adhesion promoter is surface exposed and an organic component (OC) of the adhesion promoter penetrates the surface, and a mar resistant coating contacting the substrate absent an intermediate layer. Processes of forming such materials are also provided.

### CROSS REFERENCE TO RELATED APPLICATIONS

The application depends from and claims priority to U.S. Provisional Application No. 61/875,152 filed Sep. 9, 2014, the entire contents of which are incorporated herein by reference.

### FIELD OF THE INVENTION

The invention relates to the organic substrates with improved weatherability and mar resistance. More specifically, materials and process for their manufacture are provided that impart superior clarity following exposure to light and simultaneously provide an excellent substrate for the addition of mar resistant coatings that are more effectively adhered to the substrate thereby preventing peeling or loss of substrate contact.

### BACKGROUND OF THE INVENTION

Due to their lighter weight, impact resistance, and ease of shaping, organic resin materials are highly desirable for use in automotive surfaces. Such materials are quickly becoming the standard for bumpers, portions of door panels, or as trim or protection in areas that experience additional wear from rubbing or exposure to the elements.

Use of organic materials as a replacement for glass in automotive or other window surfaces has, however, remained elusive. This is due in part to clear organic materials suffering discoloration during weathering or having inadequate scratch resistance leading to unacceptably opaque or marred surfaces. Several solutions have been proposed to improve both of these shortcomings such as the use of a UV absorber to improve weatherability, and the addition of a scratch resistant coating on the surface of the organic substrate. Unfortunately, achieving success of both incorporation of UV absorbers and successfully adhering a mar resistant coating has been difficult.

Coating materials used for improving mar resistance are typically hydrolyzates or partial hydrolyzates of hydrolyzable organosilanes, or colloidal silica. These materials on their own will successfully impart excellent mar resistance. However, bonding them to substrate materials such as polycarbonates requires a primer layer to allow the inorganic coating material to bond to the organic substrate. While this coating addresses the needed mar resistance, the materials used in such coating layers to provide anti-scratch properties do not impart improved UV weatherability to the underlying organic substrate. Improving UV weatherability of the organic substrate material by incorporation of a UV absorber into the coating material has been attempted. However, merely incorporating the UV absorber into the coating material does not effectively prevent surface discoloration. Moreover, addition of UV absorbers to the coating material results in poor adhesion leading to peeling and premature wear.

To address this problem, the addition of UV absorbers to the inorganic coating material was recently proposed. This, however, also resulted in reduced durability of the coating. In addition, modifying the UV absorber such as with silyl-modification to chemically bond the UV absorber to the siloxane matrix of the coating material did improve UV resistance but significantly reduced the ability of the coating material to resist scratching as well as unacceptably reduced the coating flexibility.

Incorporating UV absorbers into the primer layer has also been attempted. Unfortunately, the presence of these UV absorbers in the primer material reduced the adhesion of the mar resistant coating onto the organic substrate surface. The presence of the UV absorbers in the primer layer also reduced transparency of the final material.

Overall, organic materials or coated organic materials have yet to achieve the necessary light transparency and weatherability against UV radiation to prevent discoloration, and at the same time have excellent scratch resistance such that it can be used as a glass replacement. There is a need for such materials and processes for their manufacture for use in many applications including automotive, aviation, and household.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The use of organic polymeric materials as a glass substitute in the automotive industry and other industries is highly desirable. To replace glass, however, the polymeric materials have to be modified to possess improved weatherability and scratch resistance so as to be capable of maintaining a suitable transparency over the life of the product such materials are use in. Prior attempts to impart suitable properties of such polymeric materials have universally fallen short. Thus, there is a long felt need for methods that will allow adequate modification of organic polymeric materials.

Accordingly, it is one aspect to provide methods of improving the weatherability, scratch resistance, and other properties of an organic polymeric material. The inventors found that by actively infusing molecules suitable to act as an adhesion promoter into an organic polymeric material so that active groups are presented on the surface of the material that coatings can for the first time be adequately adhered directly to the organic polymeric substrate itself without the need for a primer layer, and optionally without the need for a hardcoat layer. A process includes: providing a substrate comprising a thermoplastic material, the substrate having a surface; infusing an adhesion promoter into said surface such that a first portion of said adhesion promoter penetrates said surface to form an infused substrate material, and a second portion of said adhesion promoter extends from said surface or is present at said surface, said first portion and said second portion covalently linked; and optionally depositing a mar resistant coating or a hardcoat on said surface, said mar resistant coating or hardcoat adhering to said infused substrate material absent an intermediate layer. The mar resistant layer or hardcoat is optionally adhered with suitable affinity to provide usefulness of the resulting material as a replacement for automobile glass.

A process includes infusing an adhesion promoter into a surface of an organic polymeric material. An adhesion promoter optionally includes the formula:

IC-OTx (I)

where IC is an inorganic material; OT is an organic component comprising a hydrophobic organic tail; and x is an integer between 1 and 6. IC is optionally a metal, optionally a metal oxide. IC is optionally a silicon oxide, aluminum oxide, or derivative thereof. IC optionally includes or is a Si, Al, or other metal or metalloid. An adhesion promoter is optionally an organometallic compound. The adhesion promoter also includes an OT portion optionally covalently linked to the IC portion. An OT portion optionally includes a hydrophobic linear, branched, or cyclic organic chain covalently linked to said IC. In some aspects the OT comprises a: C₄-C₂₀ alkyl; C₄-C₂₀ ether; C₄-C₂₀ alkyl having a substituent; C₄-C₂₀ alkenyl having a substituent; C₄-C₂₀ alkynyl having a substituent; C₄-C₂₀ ester; C₄-C₂₀ hydroxyl; a C₄-C₂₀ alkenyl; or a C₄-C₂₀ alkynyl; wherein said substituent is optionally selected from the group consisting of N, O, S, F, Cl, and Si.

In some aspects, an adhesion promoter includes or is a molecule with the structure of formula II:

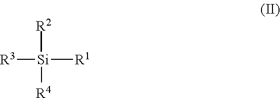

where R¹, R², R³, and R⁴ are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

In some aspects an adhesion promoter includes or is a molecule of formula III:

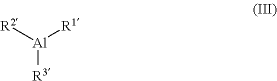

where R¹′, R²′, and R^{3′} are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

In some aspects, an adhesion promoter includes one or more cyclic moieties of 5 or more carbons. The one or more cyclic moieties optionally include 1-10 rings. Optionally, one or more of said cyclic moieties further includes one or more branches that further comprises one or more: linear, branched, cyclic or combination thereof of C₁-C₂₀ alkyl; C₁-C₂₀ ether; a substituent containing C₁-C₂₀ alkyl; a substituent containing C₂-C₂₀ alkenyl; a substituent containing C₂-C₂₀ alkynyl; C₂-C₂₀ ester; C₁-C₂₀ hydroxyl; a C₂-C₂₀ alkenyl; or a C₂-C₂₀ alkynyl.

The processes optionally further includes infusing a light stabilizer into said surface.

Optionally, in any of the processes claimed or otherwise provided, a substrate is polymerized prior to said step of infusing. Optionally, in any of the claimed or otherwise provided processes a substrate is or includes polycarbonate, polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastic.

A process optionally includes applying a hardcoat or mar resistant coat to the substrate. Optionally, a hardcoat is applied to the substrate and a mar resistant coat is applied to the hardcoat. In some aspects, a primer is absent. In some aspects, a primer and a hardcoat are absent.

Also provided are materials with suitable weatherability and mar resistance to be used as a replacement for automotive glass or for other uses that require particular requirements of a transparent material. A mar resistant thermoplastic is provided that includes: a thermoplastic substrate; and an adhesion promoter infused into a surface of said thermoplastic or portion thereof, optionally such that an inorganic component (IC) of said adhesion promoter is surface exposed and an organic component (OC) of said adhesion promoter penetrates said surface. The thermoplastic optionally further includes a mar resistant coating or a hardcoat coated directly on the thermoplastic or a hardcoat coated directly on the thermoplastic with a mar resistant coating applied directly to the hardcoat. Optionally, a primer layer or other intermediate layer is absent.

A thermoplastic includes one or more adhesion promoters infused into a surface of an organic polymeric material. An adhesion promoter optionally includes the formula:

IC-OTx (I)

where IC is an inorganic material; OT is an organic component comprising a hydrophobic organic tail; and x is an integer between 1 and 6. IC is optionally a metal, optionally a metal oxide. IC is optionally a silicon oxide, aluminum oxide, or derivative thereof. IC optionally includes or is a Si, Al, or other metal or metalloid. An adhesion promoter is optionally an organometallic compound. The adhesion promoter also includes an OT portion optionally covalently linked to the IC portion. An OT portion optionally includes a hydrophobic linear, branched, or cyclic organic chain covalently linked to said IC. In some aspects the OT comprises a: C₄-C₂₀ alkyl; C₄-C₂₀ ether; C₄-C₂₀ alkyl having a substituent; C₄-C₂₀ alkenyl having a substituent; C₄-C₂₀ alkynyl having a substituent; C₄-C₂₀ ester; C₄-C₂₀ hydroxyl; a C₄-C₂₀ alkenyl; or a C₄-C₂₀ alkynyl; wherein said substituent is optionally selected from the group consisting of N, O, S, F, Cl, and Si.

In some aspects, an adhesion promoter includes or is a molecule with the structure of formula II:

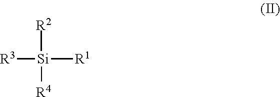

where R¹, R², R³, and R⁴ are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

In some aspects an adhesion promoter includes or is a molecule of formula III:

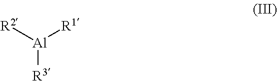

where R¹′, R²′, and R^{3′} are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

In some aspects, an adhesion promoter includes one or more cyclic moieties of 5 or more carbons. The one or more cyclic moieties optionally include 1-10 rings. Optionally, one or more of said cyclic moieties further includes one or more branches that further comprises one or more: linear, branched, cyclic or combination thereof of C₁-C₂₀ alkyl; C₁-C₂₀ ether; a substituent containing C₁-C₂₀ alkyl; a substituent containing C₂-C₂₀ alkenyl; a substituent containing C₂-C₂₀ alkynyl; C₂-C₂₀ ester; C₁-C₂₀ hydroxyl; a C₂-C₂₀ alkenyl; or a C₂-C₂₀ alkynyl.

The thermoplastic optionally further includes a light stabilizer infused into said surface.

Optionally, in any of the thermoplastics claimed or otherwise provided, a substrate is polymerized prior to being infused thereby allowing an actual infusion. Optionally, in any of the claimed or otherwise provided thermoplastics, the substrate materials is or includes polycarbonate, polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastic.

### BRIEF DESCRIPTION OF THE DRAWINGS

FIG. 1 illustrates light transmission through an organic substrate or an infusion agent in an infusion solvent;

FIG. 2 illustrates light transmission through uninfused and infused polycarbonate illustrating successful infusion of a charged alkyl group into an organic substrate; and

FIG. 3 illustrates light transmission through adhesion promoter uninfused and infused polycarbonate illustrating successful infusion of a benzylamino-silane into an organic substrate.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the compositions and processes are described as an order of individual steps or using specific materials, it is appreciated that described steps or materials may be interchangeable such that the description of the invention includes multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

The processes provided are useful for improving adherence of a mar resistant coating to an organic substrate such as polycarbonates, as one example, while simultaneously proving improved weatherability. The invention has utility as materials for use in automotive surfaces such as a glass replacement, among many other uses. Although much of the invention is described with respect to polycarbonates, it is appreciated that many other organic materials such as polyethylene terephthalate (PET), poly(methyl methacrylate) (PMMA), and acrylonitrile butadiene styrene (ABS), among others may also be used.

Processes for the formation of a mar resistant organic thermoplastic material having excellent weatherability are provided. The term “mar” as used herein is intended to mean scratch and mar as the term is traditionally used. The resulting thermoplastic materials achieve such properties optionally without the need for a primer layer between the underlying thermoplastic and a mar resistant coating that is a hallmark of prior systems. As such, in some embodiments, an intermediate primer layer is absent between the organic substrate and the mar resistant coating. In addition, the materials are resistant to discoloration due to UV light by successfully co-infusing one or more light stabilizers along with an adhesion promoter into the outer surface of the substrate material optionally absent the presence of a light stabilizer dispersed throughout the organic substrate. The resulting materials for the first time offer the necessary UV weatherability and mar resistance to be useful in many exterior applications such as transparent automotive surfaces, as one example.

A process includes infusing into the surface of an organic substrate an adhesion promoter and optionally a UV absorber. Subsequent deposition of a mar resistant coating material is thereby able to effectively adhere to the organic substrate and provide the necessary mar resistance while the infused light absorber is present to prevent discoloration or degradation. The resulting materials for the first time provide both excellent mar resistance and weatherability.

A process includes infusing an adhesion promoter into the outer surface of an organic substrate. The process of infusion optionally excludes a covalent interaction between an adhesion promoter and an organic substrate. Optionally, an organic substrate is a solid, cured polymeric organic material prior to infusion. An organic substrate is optionally a thermoplastic material. A thermoplastic material is optionally one or more of, polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastics. In particular embodiments, a thermoplastic is a polyolefin. In some embodiments, a thermoplastic is a polycarbonate. Illustrative examples of a polycarbonate include those sold under the trade names LEXAN (combination of bisphenol A with phosgene), MAKROLON, or MAKROCLEAR, PANLITE, CALIBRE, TRIREX, among others.

For the preparation of polycarbonates for the compositions according to the invention, reference may be made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally to Dres. U. Grigo, K. Kircher and P. R. Müller, “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Materials are provided that have an infusion of an adhesion promoter that includes an inorganic component and one or more organic tails as an organic component. The combination of the organic component with the inorganic component provides chemical association between a coating and an organic substrate. As typical mar resistant coating materials are inorganic, the presence of the inorganic component of the adhesion promoter allows excellent association to the promoter. The covalent or covalent-like interaction between the inorganic component and the organic component of the adhesion promoter provides chemical association with the organic substrate. This effectively bonds the coating to the organic substrate. The presence of additional light stabilizers does not significantly reduce the ability of the adhesion promoter to adhere the coating material to the substrate.

An adhesion promoter functions to adhere an inorganic coating to an underlying organic substrate material into which it is infused. The presence of an organic oligomeric tail in an adhesion promoter anchors the inorganic component to the surface of the thermoplastic substrate. As such an adhesion promoter includes the structure of Formula I:

IC-OTₓ (I)

where IC is an inorganic material illustratively those including silica or aluminum, OT is a tail structure optionally capable of associating with a thermoplastic material, and x is an integer between 1 and 6. Illustratively, an IC is a metal such as a metal oxide. Such metals are illustratively silicon oxides, aluminum oxides, or derivatives thereof. An adhesion promoter is optionally an organometallic compound. An organometallic compound is a molecule that includes a metal covalently or covalent-like bonded to an organic component including carbon. Illustrative organometallics include organosilicons and organoaluminum materials.

An OT group is optionally a hydrophobic linear, branched, or cyclic organic chain covalently linked to an inorganic component, optionally via a stable C-M bond or via an intermediate group, optionally an ether linkage. Optionally, an OT group includes a: C₁-C₂₀ alkyl; C₁-C₂₀ ether; C₁-C₂₀ alkyl having a substituent of N, O, or S; C₁-C₂₀ ester; C₁-C₂₀ alcohol; a C₁-C₂₀ alkenyl; or a C₁-C₂₀ alkynyl. Any of such groups are optionally linear or branched. In some embodiments, an OT group is a C₈-C₂₀ alkyl, optionally a C₁₀-C₂₀ alkyl. In some embodiments, an OT group includes a cyclic or bicyclic organic moiety of 5 or more carbons. Other hydrophobic organic substituent OT groups are envisioned. In some embodiments, two or more different OT groups are associated with an IC group. Optionally, 2, 3, or 4 unique OT groups are present bound to a single IC group.

In some embodiments, an OT group includes one or more cyclic moieties of 5 or more carbons. Optionally, a cyclic moiety includes 1, 2, 3, 4, 5, 6, 7, 8, 9, 10 or more rings. A cyclic molecule optionally includes one or more branches that include a linear, branched, cyclic or combination thereof of C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

A substituent as used herein is optionally includes a N, O, S, F, Cl, Si, or other element capable of interaction with carbon. A substituent is optionally present as a, or a portion of a carbonyl, amide, urethane, ether, ester, amide, aldehyde, enone, halide, anhydride, hydroxyl, or ketone. A substituent is appreciated to be positioned on an OT at a terminus, an intermediate location, on a branch, other location, or combinations thereof. The presence of a substituent maintains the hydrophobic nature of the OT overall.

Among the numerous examples of adhesion promoters non-limiting examples include tri or tetra alkylmetal materials. It is appreciated that a metal optionally includes a metalloid such as silicon among others. An illustrative example includes triisobutylaluminium.

An adhesion promoter is optionally present at a concentration of 0.02% by weight to 0.4% by weight. Optionally, the adhesion promoter is not present in excess of 0.4% by weight. In some embodiments, an adhesion promoter is present a concentration of 0.2% by weight to 0.4% by weight.

In some embodiments, an adhesion promoter includes the structure of Formula (II):

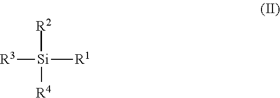

where R¹, R², R³, and R⁴ are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

In some embodiments, an adhesion promoter includes the structure of Formula (III):

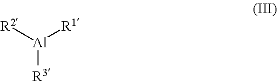

where R¹′, R²′, and R^{3′} are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

Illustrative examples of adhesion promoters illustratively include: the alkyl silanes or silanols, cyclic silanols; triorganoaluminium compounds; organoboron compounds optionally of the structure BRₙH₃₋ₙ and BRₙ(OR)₃₋ₙ; among others. Specific illustrative examples include but are not limited to: triisobutylaluminium; trimethylaluminium; Tebbe reagent ((C₅H₅)₂TiCH₂ClAl(CH₃)₂); ethylborane; t-Butyl-diphenyl-silanol; dimethyl-phenyl-silanol; diethyl(phenyl)silanol; dimethyl[2-(3-pyridinylmethyl)phenyl]silanol; Bis(3-(trifluoromethyl)phenyl)(4-(trifluoromethyl)phenyl)silanol; 4-(dimethylsilyl)phenyl](dimethyl)silanol; 4-(dimethylsilyl)phenyl](dimethyl)silanol; 4-(di-2-pyridinylamino)phenyl](dimethyl)silanol; cyclopentyl(phenyl)[2-(1-pyrrolidinyl)ethyl]silanol; (4-methoxyphenyl)dimethylsilanol; tert-butyl(dimethyl)silanol; {4-[(2-Amino-6-methyl-4-pyrimidinyl)amino]butyl}(dimethyl)silanol; Octyltriethoxysilane; Methyltriethoxysilane; Methyltrimethoxysilane; Hexadecyltrimethoxysilane; γ-Methacryloxypropyltrimethoxysilane; γ-mercaptopropyltrimethoxysilane; γ-mercaptopropyltriethoxysilane; 3-octanoylthio-1-propyltriethoxysilane; γ-Aminopropyltriethoxysilane; γ-Aminopropyltriethoxysilane; γ-Aminopropylsilsesquioxane; γ-Aminopropyltrimethoxysilane; N-β-(Aminoethyl)-gamma-aminopropyltrimethoxysilane; Benzylamino-silane; H₂NCH₂CH₂NHCH₂CH₂NHCH₂CH₂CH₂Si(OCH₃)₃; bis-(γ-Trimethoxysilylpropyl)amine; N-(β-(aminoethyl)-γ-aminopropylmethyldimethoxysilane; N-Phenyl-γ-aminopropyltrimethoxysilane; N-ethyl-3-trimethoxysilyl-methylpropamine; γ-Ureidopropyltrialkoxysilane where an alkyl is a C1 to C3; γ-Isocyanatopropyltriethoxysilane; γ-Isocyanatopropyltrimethoxysilane.

Optionally, an adhesion promoter is phenyl silane, phenyl silanol, dimethylphenylsilanol, (4-methoxyphenyl)dimethylsilanol, or methylphenyl(4-(trimethylsilylmethyl)phenyl)silane.

In some aspects, an adhesion promoter has the general structure of Formula IV

Yₐ—R—Si—X₃ (IV)

where: a is optionally from 0 to 3; Y is an optional group that may include one or more of a C₅-C₆ ring structure, primary or substituted amino, epoxy, methacryl, vinyl, mercapto, urea or isocyanate. Also, R is a linker that is optionally a: C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl. Also each X is optionally an alkoxy group, optionally a methoxy, ethoxy, isopropoxy group. Illustrative examples of silanes according to Formula IV are obtained from Momentive Performance Materials, Inc., Albany, N.Y.

Some aspects include infusion of a light stabilizer along with an adhesion promoter into the outer surface of an organic substrate. As used herein, the term “light stabilizer” is meant to include molecules that have functionality of absorbing UV light, or scavenging free radicals. A UV absorber absorbs UV light changing the energy to heat that is dissipated through the material. A radical scavenger light stabilizer (e.g., a sterically hindered amine light scavenger (HALS)) chemically reacts with a free radical. A light stabilizer as used herein is optionally a UV absorber, a radical scavenger, or both. Optionally, a light stabilizer is not a radical scavenger.

A UV absorber absorbs UV light changing the energy to heat that is dissipated through the material. Illustrative examples of UV absorbers include a benzophenone, a benzotriazole, a hydrozyphenyltriazine, an oxalic anilide, or a combination thereof. Additional examples of UV absorbers are found in U.S. Pat. No. 5,559,163, and U.S. Patent Application Publication No. 2009/0258978. Some embodiments of the invention include the UV absorber TINUVIN 384-2 that is a mixture of C₇₋₉ ester of [3-2h-benzotriazol-2-yl)-5-(1,1-dimethylethyl)-4-hydroxyphenyl)]-propionic acid (herein tinuvin 384-2), TINUVIN 1130 (methyl 3-[3-(benzotriazol-2-yl)-5-tert-butyl-4-hydroxyphenyl]propanoate) (herein tinuvin 1130), or UV416 (2-(4-Benzoyl-3-hydroxyphenoxy)ethyl acrylate).

A radical scavenger light stabilizer (e.g., a sterically hindered amine light scavenger (HALS)) chemically reacts with a free radical. Examples of a HALS include the ester derivatives of a decanedioic acid, such as a HALS I [bis(1,2,2,6,6,-pentamethyl-4-poperidinyl)ester] and/or a HALS II [bis(2,2,6,6,-tetramethyl-1-isooctyloxy-4-piperidinyl)ester].

A light stabilizer, when present is optionally provided at a concentration of 0.01% to 1.2% or any value or range therebetween, optionally 0.15% to 0.3%.

An adhesion promoter and optionally a light stabilizer are infused into a substrate by any of several processes. In some embodiments, infused into an organic substrate is by the processes of U.S. Pat. Nos. 6,733,543; 6,749,646; 7,175,675; 7,504,054; 6,959,666; 6,949,127; 6,994,735; 7,094,263; 8,206,463; or 7,921,680. In some embodiments, an adhesion promoter and a light stabilizer are infused into an organic substrate as described in U.S. Patent Application Publication Nos. 2008/0067124; 2009/0297830; or 2009/0089942.

An adhesion promoter is infused into the surface of an organic substrate. An organic substrate is appreciated to optionally be pre-polymerized prior to infusion with the adhesion promoter. An adhesion promoter is dissolved in an infusion solvent such as a water/ethanol mix, or ethanol (others are operable). An infusion solvent is optionally an aqueous solution, or a solution of one or more organic solvents or solutes. In some embodiments, an infusion solvent includes water, an adhesion promoter, and optionally one or more additives such as a light stabilizer. An additive is illustratively one more surfactants or emulsifiers.

An adhesion promoter is optionally dissolved into an infusion solvent at a concentration of 0.01% by weight to 0.4% by weight, optionally 0.02% to 0.4% by weight, optionally from 0.02% to 0.08% by weight.

An infusion solvent is optionally an aqueous solution wherein water is present in an amount of less than or equal to 98 percent by weight, optionally less than or equal to 80 percent by weight, optionally less than or equal to 75 percent by weight. In some embodiments, water is present in an infusion solvent in an amount of at least 50 or 51 percent by weight, optionally at least 60 percent by weight, and optionally at least 65 percent by weight. Water may be present in the infusion solvent in an amount ranging from 50 to 85 percent by weight or any value or range therebetween, with particular ranges being preferred. For example, water may be present in the infusion solvent in an amount from 50 (or 51) to 85 percent by weight, optionally 60 to 87 percent by weight, optionally in an amount of from 65 to 75 percent by weight, optionally 70 percent by weight. In some embodiments, water is present from 85 to 99 percent by weight, optionally 90 to 98 percent, optionally 95 to 98 percent by weight, optionally 98 percent by weight. The percent weights being based on the total weight of the infusion solvent. The water used is optionally deionized water or distilled water the preparation of each of which is well known in the art.

An infusion solvent optionally includes one or more emulsifiers. Illustrative examples of an emulsifier include ionic or non-ionic emulsifiers, or mixtures thereof. Illustrative examples of an anionic emulsifier include: amine salts or alkali salts of carboxylic, sulfamic or phosphoric acids, for example, sodium lauryl sulfate, ammonium lauryl sulfate, lignosulfonic acid salts, ethylene diamine tetra acetic acid (EDTA) sodium salts, and acid salts of amines, such as, laurylamine hydrochloride or poly(oxy-1,2-ethanediyl), α-sulfo-omega-hydroxy ether with phenol 1-(methylphenyl)ethyl derivative ammonium salts. An emulsifier is optionally an amphoteric emulsifier illustratively: lauryl sulfobetaine; dihydroxy ethylalkyl betaine; amido betaine based on coconut acids; disodium N-lauryl amino propionate; or the sodium salts of dicarboxylic acid coconut derivatives. Typical non-ionic emulsifiers include ethoxylated or propoxylated alkyl or aryl phenolic compounds, such as octylphenoxypolyethyleneoxyethanol. A specific emulsifier used is diethylene glycol.

An emulsifier is optionally present in an infusion solvent in an amount from 0 to 15 weight percent, optionally 7 to 15 weight percent, optionally 10 to 15 weight percent.

A substrate is heated to an infusion temperature. An infusion temperature is below the melting temperature of the organic substrate material but sufficient to soften the material without stressing the material configuration (e.g. shape). An infusion temperature is optionally from 60° C. to 98° C., or any value or range therebetween. Optionally, an infusion temperature is 95° C. for PC and 70° C. for less heat stable polymers. Optionally, an infusion solvent is preheated or heated in the presence of an organic substrate, optionally to any infusion temperature less than 100° C. Optionally, an infusion temperature is between 70° C. and 95° C.

A process for forming an adhesion promoter infused organic substrate optionally includes mixing a thermoplastic material with an infusion solvent containing an adhesion promoter and optionally a light stabilizer for an infusion time. Mixing is optionally immersing an organic substrate material in an infusion solvent, spraying an infusion solvent on a colored thermoplastic, or other mixing recognized by one of skill in the art. An infusion time is optionally any time from 1 minute to 120 minutes, or more. In particular embodiments, an infusion time is optionally from 1 second to 30 minutes, optionally from 1 second to 20 minutes, optionally from 1 second to 10 minutes, optionally from 10 seconds to 3 minutes. An infusion time is optionally 1, 2, 3, 4, 5, 6, 7, 8, 9, 10, 20, 30, 40, 50, seconds, or 1, 2, 3, 4, 5, 6, 7, 8, 9, 10, 15, 20, 25, or 30 minutes. As one illustrative example, an infusion time for polycarbonate may be 1 to 10 minutes.

Following infusion, an adhesion promoter -infused substrate is optionally washed, dried, etc. Washing is optionally performed by a cold solvent rinse followed by a water rinse. Optionally, a water rinse is use without a cold-solvent rinse. The substrate is optionally dried by forced air, optionally heated forced air, gently wiped, or air dried.

An adhesion promoter is infused into the surface of an organic substrate to a depth of 0.0005 inches to 0.0010 inches with the UV absorber at around 7 mils. The depth of infusion in most cases is limited to 2× the length of the OTx. In many embodiments, the depth of infusion is approximately the length of the OTx such that the IC group remains surface exposed.

Following infusion of an adhesion promoter and optionally a light stabilizer into the surface of the organic substrate, one or more hardcoats and/or mar resistant coatings are optionally applied to the surface. Unlike prior systems that required a primer material between the organic substrate and the hardcoat to promote adequate adhesion between the two, the use of an adhesion promoter allows direct association between the organic substrate and one or more hardcoat or mar resistant layers. The use of an adhesion promoter optionally negates the need of a primer allowing direct application of the hardcoat to the organic substrate surface as is traditionally required for adequate performance. As such, a mar resistant organic material optionally excludes a primer layer between the organic substrate and a hardcoat layer.

In some aspects, one or more hardcoat layers are coated onto an adhesion promoter infused organic substrate. Illustrative examples of hardcoat on organic polymeric materials optionally include those described in U.S. Patent Application Publication No. 2006/0147674, or U.S. Pat. No. 8,216,679. Specific examples of hardcoat include polymerization curable monomers/oligomers resins or sol-gel glass. More specific examples of a material used in a hardcoat layer include an organo-silicon, an acrylic, a urethane, a melamine, or an amorphous SiOₓC_{y}H_{z}. Optionally, a hardcoat layer includes resins include acrylic resins, urethane resins, epoxy resin, phenol resin, and polyvinylalcohol. In some embodiments, the hardcoat includes dipentaerythritol pentaacrylate (available, for example, under the trade designation “SR399” from Sartomer Company, Exton, Pa.), pentaerythritol triacrylate isophorondiisocyanate (IPDI) (available, for example, under the trade designation “UX5000” from Nippon Kayaku Co., Ltd., Tokyo, Japan), urethane acrylate (available, for example, under the trade designations “UV 1700B” from Nippon Synthetic Chemical Industry Co., Ltd., Osaka, Japan; and “UB6300B” from Nippon Synthetic Chemical Industry Co., Ltd., Osaka, Japan), trimethyl hydroxyl di-isocyanate/hydroxy ethyl acrylate (TMHDI/HEA, available, for example, under the trade designation “EB4858” from Daicel Cytech Company Ltd., Tokyo, Japan), polyethylene oxide (PEO) modified bis-A diacrylate (available, for example, under the trade designation “R551” from Nippon Kayaku Co., Ltd., Tokyo, Japan), PEO modified bis-A epoxyacrylate (available, for example, under the trade designation “3002M” from Kyoeishi Chemical Co., Ltd., Osaka, Japan), silane based UV curable resin (available, for example, under the trade designation “SK501M” from Nagase ChemteX Corporation, Osaka, Japan), and 2-phenoxyethyl methacrylate (available, for example, under the trade designation “SR340” from Sartomer Company); and the mixture of thereof. In some aspects, use of di-functional resins (e.g., PEO modified bis-A diacrylate (“R551”) and trimethyl hydroxyl di-isocyanate/hydroxy ethyl acrylate (TMHDI/HEA) (available, for example, under the trade designation “EB4858” from Daicel Cytech Company Ltd.) may improve the hardness, impact resistance, and flexibility of the hardcoat. In some embodiments, it may be desirable to use curable monomers or oligomers capable of forming three-dimensional structure.

Optionally, the hardcoat further comprises crosslinking agents. Exemplary crosslinking agents include poly(meth)acryl monomers selected from the group consisting of (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing; and combinations thereof. Such materials are commercially available, including at least some that are available, for example, from Sartomer Company; UCB Chemicals Corporation, Smyrna, Ga.; and Aldrich Chemical Company, Milwaukee, Wis. Other useful (meth)acrylate materials include hydantoin moiety-containing poly(meth)acrylates, for example, as reported in U.S. Pat. No. 4,262,072 (Wendling et al.).

In some aspects a crosslinking agent includes at least three (meth)acrylate functional groups. Commercially available crosslinking agents illustratively include those available from Sartomer Company such as trimethylolpropane triacrylate (TMPTA) (available under the trade designation “SR351”), pentaerythritol tri/tetraacrylate (PETA) (available under the trade designations “SR444” and “SR295”), and pentraerythritol pentaacrylate (available under the trade designation “SR399”). Further, mixtures of multifunctional and lower functional acrylates, such as a mixture of PETA and phenoxyethyl acrylate (PEA), available from Sartomer Company under the trade designation “SR399”, may also be utilized. Crosslinking agents may be used as the curable monomers or oligomers.

A hardcoat layer optionally includes one or more inorganic materials, illustratively, alumina, tin oxides, antimony oxides, silica (SiO, SiO₂), zirconia, titania, ferrite, mixtures thereof, or mixed oxides thereof; metal vanadates, metal tungstates, metal phosphates, metal nitrates, metal sulphates, or metal carbides.

The hardcoat layer may be extruded or cast as thin films or applied as a discrete coating. Optionally, a hardcoat layer is applied by dip coating, flow coating, spray coating, curtain coating, or other techniques known to those skilled in the art. A variety of additives may be added to the hardcoat such as colorants (tints), rheological control agents, mold release agents, antioxidants, ultraviolet absorbing (UVA) molecules, and IR absorbing or reflecting pigments, among others.

Aspects of the coated organic substrates include a mar resistant coating that optionally includes or is free of a polymeric material, the mar resistant coating either layered upon a hardcoat layer or applied directly on the surface of the infused substrate. Illustrative examples of mar resistant coatings include but are not limited to of such organo-silicon materials include trialkoxysilanes or triacyloxysilanes such as methyltrimethoxysilane, methyltriethoxysilane, methyltrimethoxyethoxysilane, methyltriacetoxysilane, methyltripropoxysilane, methyltributoxysilane, ethyltrimethoxysilane, ethyltriethoxysilane, vinyltrimethoxysilane, vinyltriethoxysilane, vinyltracetoxysilane, vinyltrimethoxyethoxysilane, phenyltrimethoxysilane, phenyltriethoxysilane, phenyltriacetoxysilane, gamma-chloropropyltrimethoxysilane, gamma-chloropropyltriethoxysilane, gamma-chloropropyltripropoxysilane, 3,3,3-trifluoropropyltrimethoxysilane gamma-glycidoxypropyltrimethoxysilane, gamma-glycidoxypropyltriethoxysilane, gamma-(beta-glycidoxyethoxy)propyltrimethoxysilane, beta-(3,4-epoxycyclohexyl)ethyltrimethoxysilane, beta-(3,4-epoxycyclohexyl)ethyltriethoxysilane, gamma-methacryloxypropyltrimethyoxysilane, gamma-aminopropyltrimethoxysilane, gamma-aminopropyltriethoxysilane, gamma-meraptopropyltrimethoxysilane, gamma-mercaptopropyltriethoxysilane, N-beta(aminoethyl)-gamma-aminopropyltrimethoxysilane, beta-cyanoethyltriethoxysilane and the like; as well as dialkoxysilanes or diacyloxysilanes such as dimethyldimethoxysilane, phenylmethyldimethoxysilane, dimethyldiethoxysilane, phenylmethyldiethoxysilane, gamma-glycidoxypropylmethyldimethoxysilane, gamma-glycidoxypropylmethyldiethoxysilane, gamma-glycidoxypropylphenyldimethoxysilane, gamma-glycidoxypropylphenyldiethoxysilane, gamma-chloropropylmethyldimethoxysilane, gamma-chloropropylmethyldiethoxysilane, dimethyldiacetoxysilane, gamma-methacryloxypropylmethyldimethoxysilane, gamma-metacryloxypropylmethyldiethoxysilane, gamma-mercaptopropylmethyldimethoxysilane, gamma-mercaptopropylmethyldiethoxysilane, gamma-aminopropylmethyldimethoxysilane, gamma-aminopropylmethyldiethoxysilane, methylvinyldimethoxysilane, methylvinyldiethoxysilane and the like.

A mar resistant layer optionally includes or is exclusively one or more inorganic materials, illustratively, alumina, tin oxides, antimony oxides, silica (SiO, SiO₂), zirconia, titania, ferrite, mixtures thereof, or mixed oxides thereof; metal vanadates, metal tungstates, metal phosphates, metal nitrates, metal sulphates, or metal carbides.

The mar resistant layers may be coated onto the substrate by dip coating in liquid followed by solvent evaporation, or by plasma enhanced chemical vapor deposition via a suitable monomer. Alternative deposition techniques such as flow coating and spray coating are also suitable. To improve the abrasion resistance of the hardcoating, subsequent coatings of the mar resistant layer may be added, preferably within a 48 hour period to as to avoid aging and contamination of the earlier coatings.

The addition of a glass-like mar-resistant coating or hardcoat onto an infused organic substrate may be achieved by one of many processes including: Plasma Enhanced Chemical Vapor Deposition (PECVD) which provides an extremely hard, scratch resistant surface; sputtering technologies; and E-beam evaporation. PECVD methodologies are reviewed by Gilliam, M. A. and Gasworth, S., Proceedings of Society of Vacuum Coaters Annual Conference, Chicago, Ill., USA, 19-24 April 2008; and Seuber et al., Coatings, 2012; 2:221-234. Additional a methodologies may be found in Park and Rhee, Surface and Coatings Technology 2004; 179: 229-236.

The reactive reagent for the PECVD process may include a volatile organosilicon compound that is illustratively, but is not limited to octamethylcyclotetrasiloxane (D4), tetramethyldisiloxane (TMDSO), hexamethyldisiloxane (HMDSO), or another volatile organosilicon compound. The organosilicon compounds are oxidized, decomposed, and polymerized in the arc plasma deposition equipment, typically in the presence of oxygen and an inert carrier gas, such as argon, to form a mar resistant layer. The composition of the resulting mar resistant layer may vary from SiOₓ to SiOₓC_{y}H_{z} where x, y, and z vary depending on the specific organosilicon material used. Other illustrative materials suitable for the mar resistant layer include silicon monoxide, silicon dioxide, silicon oxycarbide, and hydrogenated silicon oxycarbide, among others, as well as mixtures thereof.

The resulting coated substrates have excellent scratch resistance. Scratch resistance for automotive hardcoat applications is governed by a Federal Motor Vehicle Safety Standard [Federal Motor Vehicle Safety Standard 205; US Department of Transportation: Washington, D.C., USA, 2006] and accompanying test method [Abrasion Resistance; American National Standard for Safety Glazing Materials for Glazing Motor Vehicles and Motor Vehicle Equipment Operating on Land Highways—Safety Standard, Tests 17 and 18; SAE: Warrendale, Pa., USA, 1997]. Such testing procedures and the requirements for such materials are discussed by Seubert et al., Coatings, 2012; 2, 221-234; doi:10.3390/coatings2040221.

The resulting thermoplastic or other organic polymeric materials have suitable weatherability or scratch resistance to satisfy the Federal Motor Vehicle Safety Standard (Federal Motor Vehicle Safety Standard 205; US Department of Transportation: Washington, D.C., USA, 2006) as tested by the test method of Abrasion Resistance; American National Standard for Safety Glazing Materials for Glazing Motor Vehicles and Motor Vehicle Equipment Operating on Land Highways—Safety Standard, Tests 17 and 18; SAE: Warrendale, Pa., USA, 1997, or as tested by Taber Abraser (Abrader) with the protocol available online at http://www.taberindustries.com/taber-rotary-abraser (last accessed on 9 Sep. 2014).

Various aspects of the present invention are illustrated by the following non-limiting examples. The examples are for illustrative purposes and are not a limitation on any practice of the present invention. It will be understood that variations and modifications can be made without departing from the spirit and scope of the invention. Reagents illustrated herein are commonly commercially available, and a person of ordinary skill in the art readily understands where such reagents may be obtained.

### EXPERIMENTAL

### EXAMPLE 1

### Infusion of Hydrophobic Tail Bound Charged Material

As a proof of concept experiment to determine if charged groups could be infused into the surface of a thermoplastic material, the anti-static agent stearamidopropyldimethyl-2-hydroxyethylammonium nitrate (CYASTAT SN from Cytec Indus. Inc., Woodland Park, N.J.) is used to infuse a polycarbonate sheet (10 mil thick). The agent is dissolved in isopropanol as an infusion solvent and heated to a temperature of 95° C. The polycarbonate substrate is not preheated prior to infusion. The polycarbonate substrate is immersed in the agent containing infusion solvent for an infusion time of 2 minutes. The material is removed and tested to determine if any of the agent was successfully infused into the polycarbonate.

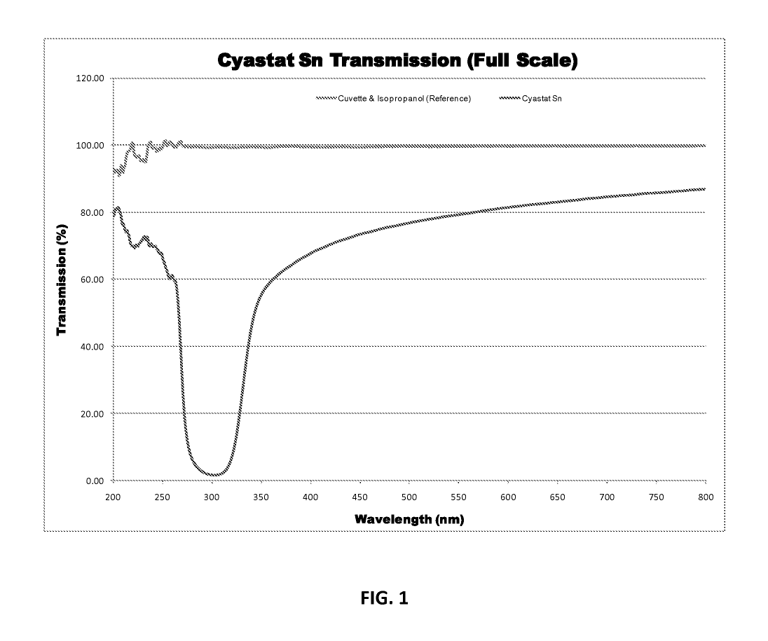

A sample of anti-static agent in isopropanol, the polycarbonate material following immersion in a control infusion solvent absent the anti-static agent, and the polycarbonate material following immersion in the anti-static agent containing infusion solvent are each subjected to scanning transmission spectrometry to discern whether any agent is infused into the surface of the material. As is observed in FIG. 1, the anti-static agent in isopropanol has a distinct transmission spectrum with the greatest absorbance found between 275 nm to 350 nm.

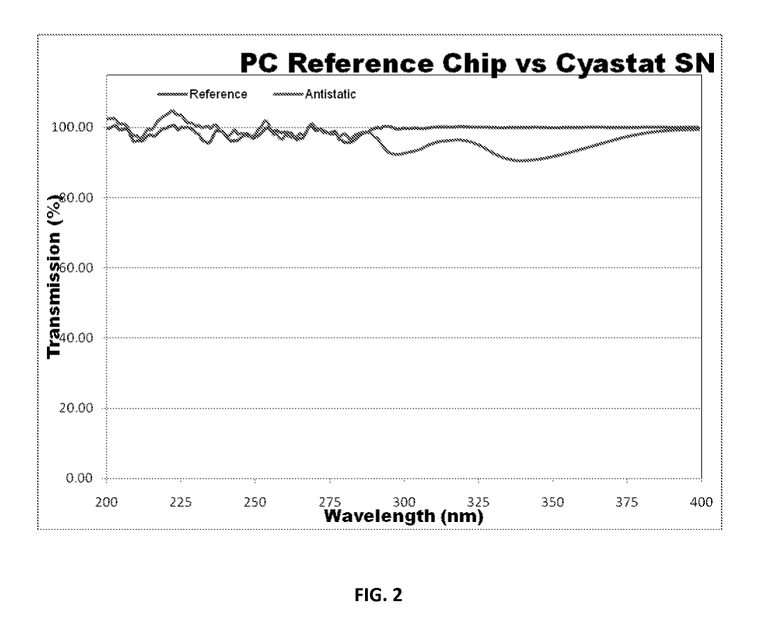

When the infused polycarbonate material and the polycarbonate control are subjected to the same process, the infused polycarbonate demonstrates a reduction in transmission between 275 and 350 nm whereas the control polycarbonate demonstrates 100% transmission at these wavelengths (FIG. 2).

These data demonstrate that some level of the anti-static agent is successfully infused into the surface of the polycarbonate material.

The infused and control polycarbonate sheets are also tested for the presence of the anti-static agent on the surface by a simple carbon black association test. Test and control sheets are coated with a small amount of carbon black (high static content material). The sheets are then inverted and any non-adhered carbon black falls from the surface. The anti-static agent infused polycarbonate sheet is distinctly more free of carbon black than the control which remains fully coated with the carbon black. These data further demonstrate successful infusion of the anti-static agent into the surface of the polycarbonate sheet.

### EXAMPLE 2

The experiment of Example 1 is repeated with a different infusion solvent. Samples of PET and PC (75 grams each) are immersed in an anti-static agent containing infusion solvent including water (70% w/w), anti-static agent 2-butoxyethanol (20% w/w) (or control with no agent), and emulsifier (diethylene glycol) (10% w/w). The solvent is preheated to a temperature of 90° C. The thermoplastics are immersed in the solvent for a period of 5 minutes. The samples are removed, rinsed in water, and dried overnight at ambient temperature.

The resulting materials are tested as in example 1 with similar results.

These data demonstrate significant infusion of the anti-static agent into the thermoplastic materials indicating that the hydrophobic tail bound light stabilizers will also successfully infuse into thermoplastic substrates to provide a UV light discoloration resistant material.

### EXAMPLE 3

The adhesion promoter benzylamino-silane having the following structure:

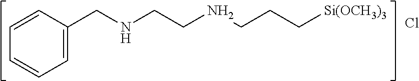

Is combined in the infusion solvent of Example 2 at 2.5 g/L, 5 g/L and 7.5 g/L. As controls the adhesion promoter is combined with water to form a slurry or is applied directly to the surface as supplied from the vendor Momentive Performance Materials and baked dry at 170° F.

A polycarbonate sheet is immersed in the infusion solvent for infusion periods of 5, 10 and 15 minutes after which time the material is removed and residual solvent rinsed away. The material is allowed to dry and then subjected to testing by light transmission or by a crosscut test. The crosscut test is performed by scratching the surface of the test material with a plurality of vertical lines crossed substantially at 90 degrees with a plurality of horizontal lines to form squares. A tape is applied to the surface and removed.

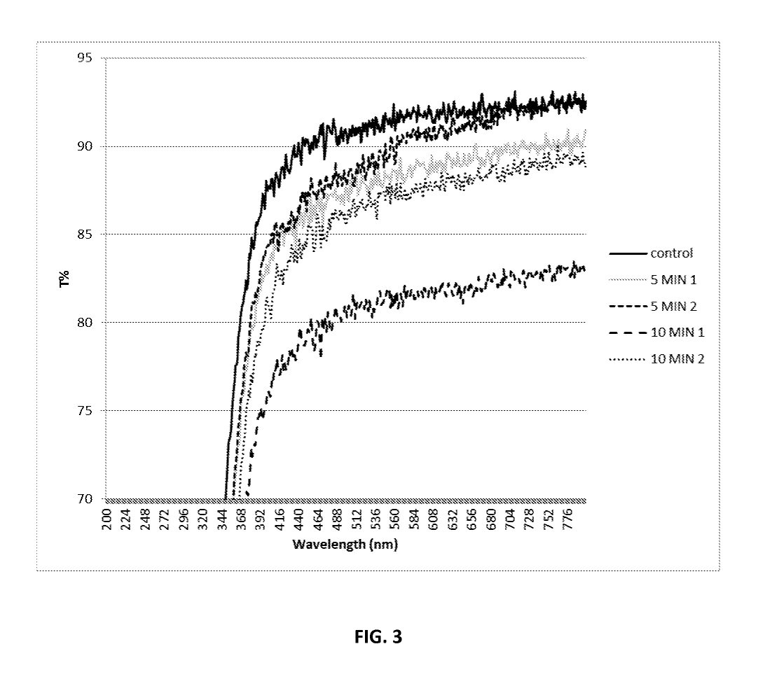

The results of infusion at zero, 5 min and 10 min of infusion are illustrated in FIG. 3. The material infused for 5 min shows reduced transmission relative to polycarbonate alone demonstrating the presence of the adhesion promoter in the substrate.

The infused or coated materials are tested by the crosscut test or challenge by rubbing with isopropyl alcohol (IPA). Results are presented in Table 1:

TABLE 1

| Sample | IPA Test | Cross-cut test |
|---|---|---|
| 15 min Infusion | Passed | 0% |
| 10 min Infusion | Passed | 0% |
| 5 min Infusion | Passed | 0% |
| 5 min water bath | Passed* | 0% |
| promoter mixed with water and | Failed | 65% |
| applied | | |
| promoter applied on surface then | Failed | 75% |
| dried | | |
| promoter applied on surface then | Failed | 5% |
| wetted then dried | | |

*Became super tacky with IPA

All samples infused for 5, 10, or 15 minutes showed no removal of material indicating that the infused benzylamino-silane is infused into the surface and remains there upon challenge. In contrast, the coated control samples are readily removed from the polycarbonate surface by the tape showing between 5% and 75% of the squares removed by the tape.

With challenge by IPA, the infused samples showed no removal of adhesion promoter, but the coated samples showed easy removal with the direct coating showing virtually no affinity for the surface of the polycarbonate substrate.

These data indicate that the adhesion promoter benzylamino-silane is infused into the surface such that can readily withstand physical challenge.

### EXAMPLE 4

The adhesion promoter γ-mercaptopropyltrimethoxysilane with the following structure HSCH₂CH₂CH₂Si(OCH₃)₃ obtained from Momentive Performance Materials is infused or coated onto the surface of polycarbonate materials as per Examples 2 and 3 and subjected to testing for infusion and robustness of the association with the polycarbonate as per Example 3. The adhesion promoter showed results similar to that of Example 3 indicating robust infusion into the surface of the polycarbonate.

### EXAMPLES 5-25

The adhesion promoters of Table 2 obtained from Momentive Performance Materials are infused into the surface of polycarbonate using the procedure of Example 2 and tested as per Example 3.

TABLE 2

| Example | Adhesion Promoter | Formula |
|---|---|---|
| 5 | Octyltriethoxysilane | CH3(CH2)7Si(OCH2CH3)3 |
| 6 | Methyltriethoxysilane | CH3Si(OCH2CH3)3 |
| 7 | Methyltrimethoxysilane | CH3Si(OCH3)3 |
| 8 | Hexdecyltrimethoxysilane | CH3(CH2)15Si(OCH3)3 |
| 9 | Vinyltriethoxysilane | CH2═CHSi(OCH2CH3)3 |
| 10 | Vinyltrimethoxysilane | CH2═CHSi(OCH3)3 |
| 11 | Vinyl-tris-(2-methoxyethoxy)silane | CH2═CHSi(OCH2CH2OCH3)3 |
| 12 | gamma-Methacryloxypropyltrimethoxysilane | CH2═C(CH3)CO2CH2CH2CH2Si(OCH3)3 |
| 13 | 3-glycidoxypropylmethyldiethoxysilane | 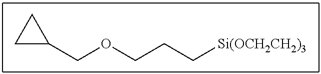 |
| 14 | gamma-mercaptopropyltriethoxysilane | HSCH2CH2CH2Si(OCH2CH3)3 |
| 15 | 3-octanoylthio-1-propyltriethoxysilane | CH3(CH2)6C(═O)SCH2CH2CH2Si(OCH2CH3)3 |
| 16 | gamma-Aminopropyltriethoxysilane | H2NCH2CH2CH2Si(OCH2CH3)3 |
| 17 | gamma-Aminopropyltriethoxysilane | H2NCH2CH2CH2Si(OCH2CH3)3 |
| 18 | gamma-Aminopropylsilsesquioxane | (H2NCH2CH2CH2SiO1.5)n |
| 19 | gamma-Aminopropyltrimethoxysilane | H2NCH2CH2CH2Si(OCH3)3 |
| 20 | N-beta-(Aminoethyl)-gamma- | H2NCH2CH2NHCH2CH2CH2Si(OCH3)3 |
| | aminopropyltrimethoxysilane | |
| 21 | Triaminofunctional silane | H2NCH2CH2NHCH2CH2NHCH2CH2CH2Si(OCH3)3 |
| 22 | bis-(gamma-Trimethoxysilylpropyl)amine | 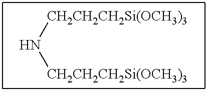 |
| 23 | N-beta-(aminoethyl)-gamma- | H2NCH2CH2NHCH2CH2CH2SiCH3(OCH3)2 |
| | aminopropylmethylmethoxysilane | |
| 24 | gamma-Isocyanatopropyltriethoxysilane | O═C═NCH2CH2CH2Si(OCH2CH3)3 |
| 25 | gamma-Isocyanatopropyltrimethoxysilane | O═C═NCH2CH2CH2Si(OCH3)3 |

The infused materials of Examples 5-26 are expected to successfully infuse into a polycarbonate substrate and show similar robust incorporation into the surface as per the adhesion promoters of Examples 3 and 4.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents and publications mentioned in the specification are indicative of the levels of those skilled in the art to which the invention pertains. These patents and publications are incorporated herein by reference to the same extent as if each individual application or publication was specifically and individually incorporated herein by reference.

1. A process of forming a mar resistant organic material comprising:
providing a substrate comprising a thermoplastic material, said substrate having a surface;
and
infusing an adhesion promoter into said surface such that an organic component first portion of said adhesion promoter penetrates said surface to form an infused substrate material, and an inorganic second portion of said adhesion promoter extends from said surface or is present at said surface, said first portion and said second portion covalently linked.

2. The process of claim 1 wherein said adhesion promoter comprises the formula
IC-OTₓ (I)
where IC is an inorganic material; OT is an organic component comprising a hydrophobic organic tail; and x is an integer between 1 and 6.

3. The process of claim 2 wherein said IC is a metal, optionally a metal oxide.

4. The process of claim 2 wherein said IC is a silicon oxide, aluminum oxide, or derivative thereof.

5-7. (canceled)

8. The process of claim 1 wherein said adhesion promoter comprises the structure of formula II: 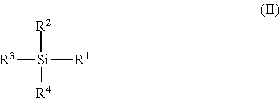
where R¹, R², R³, and R⁴ are each independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

9. The process of claim 1 wherein said adhesion promoter comprises the structure of Formula III: 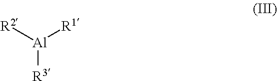
where R¹′, R²′, and R³′ are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

10-17. (canceled)

18. A mar resistant thermoplastic material comprising:
a thermoplastic substrate; and
an adhesion promoter infused into a surface of said thermoplastic or portion thereof, such that an inorganic component (IC) of said adhesion promoter is surface exposed and an organic component (OT) of said adhesion promoter penetrates said surface.

19. The thermoplastic material of claim 18 further comprising:
a mar resistant coating or hardcoat coating contacting said substrate absent an intermediate layer.

20. The material of claim 18 wherein said adhesion promoter comprises a structure having the formula
IC-OTₓ (I)
where IC is said inorganic component; OT is an organic component comprising an oligomeric tail; and x is an integer between 1 and 6.

21. The material of claim 18 wherein said IC is a metal.

22. The material of claim 18 wherein said IC comprises silicon oxide, aluminum oxide, or derivative thereof.

23. (canceled)

24. The material of claim 18 wherein said OT is a hydrophobic linear, branched, or cyclic organic chain covalently linked to said IC.

25. The material of claim 18 wherein said OT comprises a: C₄-C₂₀ alkyl; C₄-C₂₀ ether; C₄-C₂₀ alkyl having a substituent; C₄-C₂₀ alkenyl having a substituent; C₄-C₂₀ alkynyl having a substituent; C₄-C₂₀ ester; C₄-C₂₀ hydroxyl; a C₄-C₂₀ alkenyl; or a C₄-C₂₀ alkynyl; wherein said substituent is optionally selected from the group consisting of N, O, S, F, Cl, and Si.

26. The material of claim 18 wherein said adhesion promoter comprises the structure of formula II: 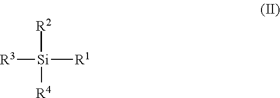
where R¹, R², R³, and R⁴ are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

27. The material of claim 18 wherein said adhesion promoter comprises the structure of Formula III: 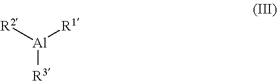
where R¹′, R²′, and R^{3′} are reach independently an H, OH, Cl, F, C₄-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₁-C₂₀ ester; C₁-C₂₀ hydroxyl; a C₂-C₂₀ alkenyl; or a C₂-C₂₀ alkynyl; a cyclic molecule including 1, 2, 3, 4, 5, 6, 7, 8, 9, 10 or more rings, optionally including one or more branches that include a linear, branched, cyclic or combination thereof of: C₁-C₂₀ alkyl; C₁-C₂₀ ether; C₁-C₂₀ alkyl having a substituent of N, O, or S; C₂-C₂₀ alkenyl having a substituent of N, O, or S; C₂-C₂₀ alkynyl having a substituent of N, O, or S; C₂-C₂₀ ester; C₁-C₂₀ hydroxyl; a C₂-C₂₀ alkenyl; or a C₂-C₂₀ alkynyl.

28. The material of claim 18 wherein said adhesion promoter comprises one or more cyclic moieties of 5 or more carbons.

29-30. (canceled)

31. The material of claim 18 further comprising a light stabilizer infused into said surface, mixed into said thermoplastic substrate material, or combinations thereof.

32. (canceled)

33. The material of claim 18 wherein said substrate comprises a polycarbonate.

34. The material of claim 18 wherein said thermoplastic substrate comprises polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastic.

35. The material of claim 18 wherein said mar resistant coating comprises SiOₓ, Si₃N₄, SiC, or combinations thereof.
